(19) United States
(12) Patent Application Publication
(10) Pub. No.: US 2019/0210560 A1
(43) Pub. Date: Jul. 11, 2019

(54) VEHICLE ACCESS AUTHORIZATION

(71) Applicant: Ford Global Technologies, LLC, Dearborn, MI (US)

(72) Inventors: Nunzio DECIA, Northville, MI (US); Nicholas Alexander SCHEUFLER, Flat Rock, MI (US); David A. HERMAN, Southfield, MI (US); David Joseph ORRIS, Allen Park, MI (US); Stephen Jay ORRIS, New Boston, MI (US)

(21) Appl. No.: 16/325,424

(22) PCT Filed: Aug. 22, 2016
(86) PCT No.: PCT/US2016/047972

§ 371 Date: Feb. 14, 2019

(51) Int. Cl. B60R 25/24; G07C 9/00

(52) U.S. Cl. CPC B60R 25/241; G07C 9/00158

(57) ABSTRACT

Data including vehicle occupant authentication information is received. A request to control a vehicle component is received. A role for the vehicle occupant is identified. A determination is made whether the identified role includes a permission to control the vehicle component. The requested control of the vehicle component is performed if the identified role includes the permission to control the vehicle component.

### BACKGROUND

An autonomous vehicle, i.e., a self-driving vehicle, may drive without intervention of a user. Thus, the vehicle may drive without any occupant or only with minor kids. Thus, an access authorization of autonomous vehicles may need an improved access and authorization.

### BRIEF DESCRIPTION OF THE DRAWINGS

FIG. 1 is a block diagram of an exemplary system for controlling access to a vehicle system.

FIG. 2 is a block diagram showing a hierarchy of roles associated with vehicle users.

FIG. 3 is a flowchart of an exemplary process for controlling vehicle components according to the roles and permissions of vehicle users.

FIG. 4 is a flowchart of another exemplary process for defining roles and associating permissions with the roles.

### DETAILED DESCRIPTION

### Introduction

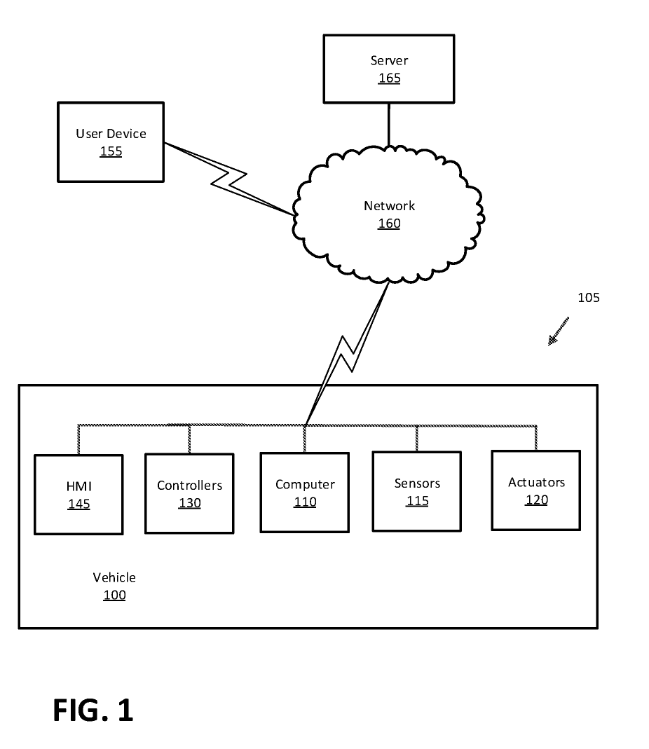

FIG. 1 illustrates an exemplary vehicle system 105. An autonomous vehicle 100 can be shared among various users, e.g., different family members of different ages. Users are persons who may be occupants of the vehicle 100. Each user may be assigned to one of a plurality of roles. The various roles with various permissions may be defined to permit or deny access to various components of the vehicle 100, such as an entertainment system, information system, navigation system, climate control system, etc. Thus, users can be assigned to a role depending on permissions and/or restriction appropriate for the particular user. For example, for a particular role the computer 110 could be programmed to navigate the vehicle 100 only to a specified location, e.g., a home address.

### System Elements

FIG. 1 illustrates an example vehicle 100 including a computer 110 that is programmed to manage access of various users to various vehicle 100 components according to user roles that are defined and implemented as described herein.

The vehicle 100 may be powered in variety of known ways, e.g., with an electric motor and/or internal combustion engine. The vehicle 100 includes the computer 110, sensors 115, actuators 120, a human machine interface (HMI) 145, and other components discussed herein below.

The computer 110 includes a processor and a memory such as are known. The memory includes one or more forms of computer-readable media, and stores instructions executable by the computer 110 for performing various operations, including as disclosed herein.

The computer 110 may operate the vehicle 100 in an autonomous or semi-autonomous mode. For purposes of this disclosure, an autonomous mode is defined as one in which each of vehicle 100 propulsion, braking, and steering are controlled by the computer 110; in a semi-autonomous mode the computer 110 controls one or two of vehicle 100 propulsion, braking, and steering.

The computer 110 may include programming to operate one or more of vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations.

The computer 110 may include or be communicatively coupled to, e.g., via a vehicle communications bus as described further below, more than one processors, e.g., controllers or the like included in the vehicle for monitoring and/or controlling various vehicle controllers 130, e.g., a powertrain controller, a brake controller, a steering controller, etc. The computer 110 is generally arranged for communications on a vehicle communication network such as a bus in the vehicle such as a controller area network (CAN) or the like.

Via the vehicle network, the computer 110 may transmit messages to various devices in the vehicle and/or receive messages from the various devices, e.g., controllers, actuators, sensors, etc., including sensors 115. Alternatively or additionally, in cases where the computer 110 actually comprises multiple devices, the vehicle communication network may be used for communications between devices represented as the computer 110 in this disclosure. Further, as mentioned below, various controllers and/or sensors 115 may provide data to the computer 110 via the vehicle communication network.

In addition, the computer 110 may be configured for communicating through a vehicle-to-infrastructure (V-to-I) interface with a server 165 via a network 160. The network 160 represents one or more mechanisms by which the user devices 155, the computer 110, and the server 165 may communicate with each other, and may be one or more of various wired or wireless communication mechanisms, including any desired combination of wired (e.g., cable and fiber) and/or wireless (e.g., cellular, wireless, satellite, microwave and radio frequency) communication mechanisms and any desired network topology (or topologies when multiple communication mechanisms are utilized). Exemplary communication networks include wireless communication networks (e.g., using one or more of cellular, Bluetooth, IEEE 802.11, etc.), dedicated short range communications (DSRC), local area networks (LAN) and/or wide area networks (WAN), including the Internet, providing data communication services.

As already mentioned, generally included in instructions stored in the memory and executed by the computer 110 is programming for operating one or more vehicle components, e.g., braking, steering, propulsion, etc., without intervention of a human operator. Using data received in the computer 110, e.g., the sensor data from the sensors 115, the server 165, etc., the computer 110 may make various determinations and/or control various vehicle components and/or operations without a driver to operate the vehicle. For example, the computer 110 may include programming to regulate vehicle operational behaviors such as speed, acceleration, deceleration, steering, etc., as well as tactical behaviors such as a distance between vehicles and/or amount of time between vehicles, lane-change minimum gap between vehicles, left-turn-across-path minimum, time-to-arrival at a particular location, intersection (without signal) minimum time-to-arrival to cross the intersection, etc.

Controllers 130, as that term is used herein, are processors that typically are programmed to control a specific vehicle subsystem. Examples include a powertrain controller, a brake controller, and a steering controller. A controller may be an electronic control unit (ECU) such as is known, possibly including additional programming as described herein. The controllers may communicatively be connected to and receive instructions from the computer 110 to actuate the subsystem according to the instructions. For example, the brake controller may receive instructions from the computer 110 to operate the brakes of the vehicle.

Sensors 115 may include a variety of devices known to provide data via the vehicle communications bus. For example, the sensors 115 may include one or more cameras, radars, or Light Detection and Ranging (LIDAR) sensors disposed in the vehicle 100 providing data encompassing at least some of the vehicle interior, exterior, or both. The data may be received by the computer 110 through a suitable interface such as in known. The computer 110 may authenticate users based on the received data.

Further, the sensors 115 may include microphones disposed in the vehicle, e.g., the interior or a trunk, providing audio data. For example, the computer 110 may communicate with a user to, e.g., identify the user of the vehicle 100, e.g., using voice recognition techniques.

The sensors 115 may include a GPS (global positioning system) device. The GPS sensor may transmit a current geographical coordinate of the vehicle 100 via the vehicle communication network, e.g., vehicle 100 bus. For example, the computer 110 may prohibit navigation of the vehicle 100, e.g., for one or more specific user roles, to any location outside a predetermined geo-fenced area, or a predetermined distance from a home location, etc. The geo-fenced area may be a geographical area identified by geographical coordinates of corners or boundaries of the geo-fenced area such as is known.

The actuators 120 are implemented via circuits, chips, or other electronic components that can actuate various vehicle subsystems in accordance with appropriate control signals as is known. For instance, the actuators 120 may be implemented via one or more relays, servomotors, etc. The actuators 120, therefore, may be used to control braking, acceleration, and steering of the host vehicle 100. Additionally, the actuators 120 may control access to the vehicle 100, e.g., release/lock doors, or components of the vehicle 100, e.g., release/lock multimedia access. The control signals used to control the actuators 120 may be generated by the computer 110, a control unit located in the vehicle 100, e.g., the brake controller, etc.

The human-machine interface (HMI) 145 can include a touch screen, an interactive voice response (IVR) system, and/or other input/output mechanisms such as are known, and can receive input data from a user and/or outputs data to the user.

A user device 155 may communicate with the computer 110 via the network 160. The user device 155 may be a smartphone or wearable computer communicating via the network 160.

The server 165 is a remote computer or computers communicating with the computer 110 via the network 160, e.g., LTE.

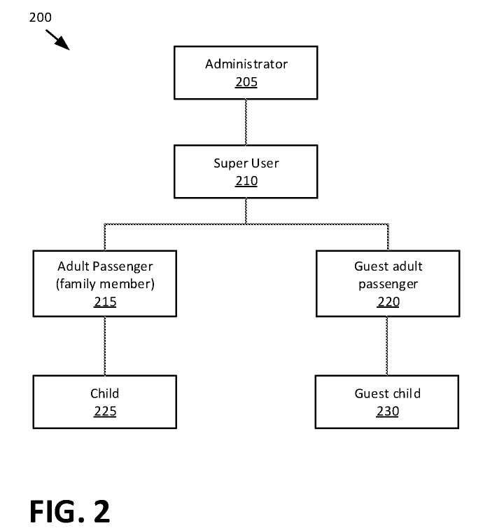

FIG. 2 illustrates a variety of roles to be associated with respective vehicle users in an example implementation. Each role corresponds to a category of vehicle user, and, as discussed below, includes permissions established for the category of user.

As shown in FIG. 2, the roles may be defined in a hierarchy 200. Roles at higher levels in the hierarchy 200 typically have greater permissions than roles at lower levels. “Permissions,” as that term is used herein, includes different combinations of rights to access, e.g., view, vehicle components and/or make modifications to settings thereof. That is, a permission specifies whether a user request for controlling one or more vehicle 100 components should be granted or denied. For example, a “viewing permission” (interchangeably referred to as an “access permission”) is a permission to view a status or a configuration of a vehicle 100 component or operation thereof, e.g., via the HMI 145. A “modifying permission” is a permission to make a change to a status or configuration of a vehicle 100 component or the operation thereof. A request to control is a user input to view certain information or modify a setting or status of a vehicle 100 component.

Thus, the permissions may include viewing or modifying permissions associated with one or more vehicle 100 components such as:
an entertainment system, e.g., to select a radio station, play media from another device such as a smartphone, etc.;
a navigation system, e.g., to view/set a destination, view/set a route;
a climate control system e.g., to view/modify a cabin thermostat setting, etc.;
a virtual driver, e.g., initiate controls such as a vehicle travel.
   Permissions and the association of permissions to a role are discussed further below in greater detail.

A user may be assigned to a role based on one or more attributes of the user. In the present context, a user attribute is a characteristic attributable to a category of people, e.g., a user age, relationship to a vehicle 100 owner (e.g., family member, spouse, etc.), driving ability (e.g., licensed or unlicensed), etc. For example, roles, i.e., different sets of permissions, could be assigned based on an ownership status with respect to the vehicle 100, age of a user, etc. A relationship among various roles may be hierarchical as shown in the hierarchy 200. In a hierarchical relationship, a first role may have a superset (i.e., a greater number) of permissions than a second role below the first role in the hierarchy.

Examples roles include administrator 205, super user 210, adult passenger 215, guest adult passenger 220, and child 225. Example of some of the permissions assigned to each of these roles are illustrated in the following table:

TABLE 1

| | | | Adult | Guest | |
|---|---|---|---|---|---|
| | Adminis- | Super | pas- | Pas- | |
| | trator | user | senger | senger | Child |
| Create/delete users and/or | ✓ | | | | |
| user groups | | | | | |
| Edit permissions associated | ✓ | | | | |
| with a user and/or user | | | | | |
| group | | | | | |
| Authorize maintenance | ✓ | ✓ | | | |
| View destinations and | ✓ | ✓ | ✓ | ✓ | ✓ |
| routes | | | | | |
| Enter/modify destinations | ✓ | ✓ | ✓ | | |
| and routes locally | | | | | |
| Enter/modify destinations | ✓ | ✓ | | | |
| and routes remotely | | | | | |
| View geo-fenced areas | ✓ | ✓ | ✓ | ✓ | |
| Enter/modify geo-fenced | ✓ | ✓ | | | |
| areas | | | | | |
| View vehicle settings | ✓ | ✓ | ✓ | ✓ | |
| Modify vehicle settings | ✓ | ✓ | ✓ | | |
| Authorize an initiation of | ✓ | ✓ | ✓ | ✓ | ✓ |
| travel locally | | | | | |
| Authorize an override of | ✓ | | | | |
| initiation of travel remotely | | | | | |
| Authorize an initiation | ✓ | ✓ | | | |
| of travel remotely | | | | | |

In the hierarchical hierarchy 200, a role such as adult passenger 215 may have a subset, i.e., some but not all, of the permissions associated with a super user 210. Alternatively, the roles may be defined in other relationships to one another. For example, roles in alternative arrangements to the example hierarchy 200 may have overlapping set of permissions but are not necessarily in a hierarchical relationship to one another.

In the present example hierarchy 200, the administrator 205 has a greater number of permissions than any other roles. As an example, an owner of the vehicle 100 may be associated with the administrator 205 role. An entity such as a vehicle dealer or a government agency may, when a vehicle 100 is sold and/or put into service, associate an entity or a person, e.g., an owner, with the administrator 205 role. For example, the entity may maintain electronic data, e.g., an electronic vehicle title document, on the server 165 which indicates the identity of the administrator 205 of the vehicle 100. The entity may provide to be stored in the computer 110 memory information for the administrator 205 to be authenticated via the HMI 145 in a known manner, e.g., by recording authentication information for biometric authentication, by providing an administrator under name and password, etc. Alternatively, an entity like a car sharing facility or an original equipment manufacturer (OEM) may be associated with the administrator 205 role, e.g., when a car is leased or rented.

A super user 210 may have a subset (which in the present context means “a lower number”) of permissions assigned to the administrator 205. As one example, a super user 210 may not have the permission to add a user to the vehicle 100 whereas the administrator 205 does have such permission.

An adult passenger 215 or guest adult passenger 220 may have a subset of permissions of the super user 210. Further, a child 225 role may have a subset of permissions associated with the adult passenger 215 role, and/or a guest child 230 may have a subset of permissions of the adult guest adult passenger role 220. For example, an adult passenger 215 may have permissions to set any destination in a broad geographic area (e.g., city, state, country) in the vehicle 100 navigation system or within a geo-fenced area as explained above. Whereas a child 225 role may have more restricted permission regarding a settable destination, e.g., the user associated with the child 225 role may be permitted to set only a destination that is a single predetermined location, e.g., a home address. A guest child 230 may be limited from selecting any destination at all, but may be a role that permits the vehicle 100 to operate.

During operation of the vehicle 100, to determine a proper set of permissions for each vehicle 100 user, the computer 110 (see FIG. 1) may authenticate one or more users, e.g., all users present in the vehicle 100 as may be detected using input from one or more sensors 115 as is known. For example, the computer 110 may authenticate a user by receiving authentication information such as a user name and password via HMI 145, biometric authentication information via a camera, or other techniques such as are known. Additionally, the computer 110 may identify a user and/or determine user characteristics (e.g., age) based on the received sensor 115 data using known techniques for such identification, e.g., image recognition. When a user is identified, the computer 110 may determine the role of the specific user, roles having permissions associated therewith, as discussed above. The computer 110 memory may store a table or the like of user identifiers and the role assigned to each user. An administrator 205, e.g., a user assigned a role having permissions to enter new users (potential vehicle occupants) into the system and to assign roles, may provide input to assign a role to each user whose identifier is stored in the memory.

Further, in some implementations, the computer 110 may be programmed to assign a user role based on a determination of one or more user characteristics, e.g., age. For example, users appearing to be twenty years of age or older, but not otherwise identified, could be assigned a guest adult passenger role 220, while users appearing to be nineteen years of age or younger could be assigned a child 225 role.

As another example of user authentication, the computer 110 may compare a voice of a user, i.e., the received audio data from the sensors 115, to voices of known users associated with stored identifiers as explained above, using voice recognition techniques (see FIG. 1). As discussed above, the computer 110 may determine the role to be assigned to the user, e.g., by assigning an age to the user based on analyzing a user's voice, or a role may be assigned according to user input and retrieved when the user is authenticated, e.g., using voice recognition and interactive voice response (IVR), as is known.

### Exemplary Process Flow

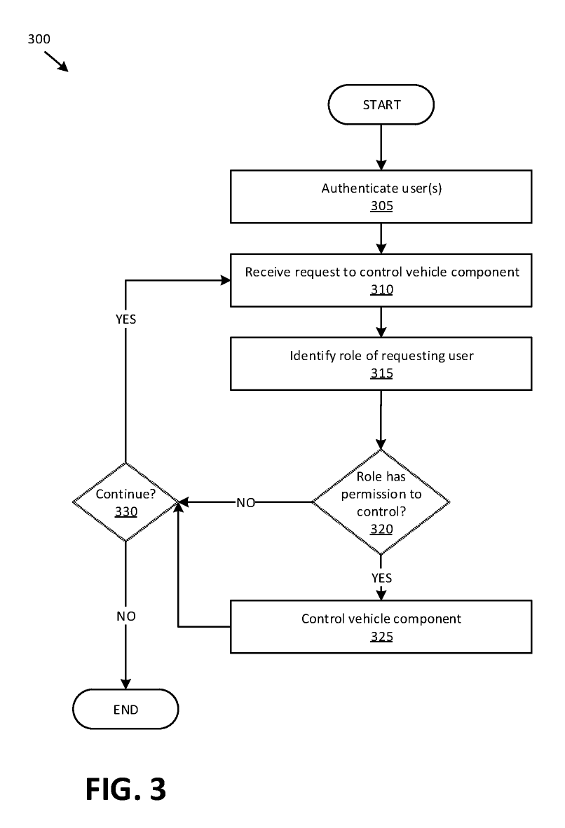

FIG. 3 illustrates an example process 300 for controlling vehicle components according to the roles and permissions of vehicle users. The vehicle users may include vehicle occupants and/or remote vehicle users (e.g., communicating via a user device 155 and the network 160 with the computer 110). For example, the computer 110 may be programmed according to the process 300 to control vehicle 100 components in accordance with permissions of a vehicle user requesting the respective control.

The process 300 begins in a block 305, in which the computer 110 authenticates a vehicle user, e.g., using input from one or more sensors 115, the HMI 145, etc. Authenticating the user typically includes identifying the user, e.g., according to a specific user name or other unique user identity stored in the computer 110 memory. Alternatively or additionally, authenticating the user could include using known techniques to determine biological characteristics of one or more users in the vehicle 100, e.g., an estimated age.

Next, in a block 310, the computer 110 receives a request to control a vehicle component, e.g., via the HMI 145, the user devices 155, etc. For example, the request to control may include a request to view a destination and a route of the vehicle 100. A request to control could include many other inputs to the computer 110, e.g., a request to authorize an initiation of travel, i.e., to authorize vehicle movement, a request to change a climate control setting, a request to play media via an infotainment system, a request to activate cabin lights, etc.

Next, in a block 315, the computer 110 identifies the role based on the user requesting to control a vehicle 100 component in the block 310. (It is assumed that the user can be identified as a user authenticated in the block 305. If not, the process 300 could end with an output on the HMI 145 that the request cannot be processed.) For example, the computer 110 may determine the role of the authenticated user based on, e.g., a table stored in a memory of the computer 110, including the vehicle 100 user identifiers and the role assigned to each user. Alternatively or additionally, the user could be identified according to a characteristic, such as age, as described above.

Next, in a decision block 320, the computer 110 determines, based on the identified role of user, whether user has permission for the requested control. For example, the computer 110 may determine permitted controls of vehicle 100 components for the identified user based on a table stored in a memory of the computer 110, including the roles and the assigned permissions to each role. If the identified user has permission for the requested control, a block 325 is executed next; otherwise, the process 300 proceeds to a decision block 330.

In the block 325, the computer 110 performs the requested control of the vehicle 100 component, e.g., by outputting a signal via the vehicle communication network to a controller 130, an actuator 120, the HMI 145, etc. For example, the computer 110 may output the destination and the route information to the HMI 145 for viewing the information or output a signal to a controller 130 to initiate a travel. Following the block 325 the process 300 proceeds to the decision block 330.

In the decision block 330, the computer 110 determines whether a new request to control a vehicle 100 component is requested. If so, the block 310 is executed next; otherwise, the process 300 ends.

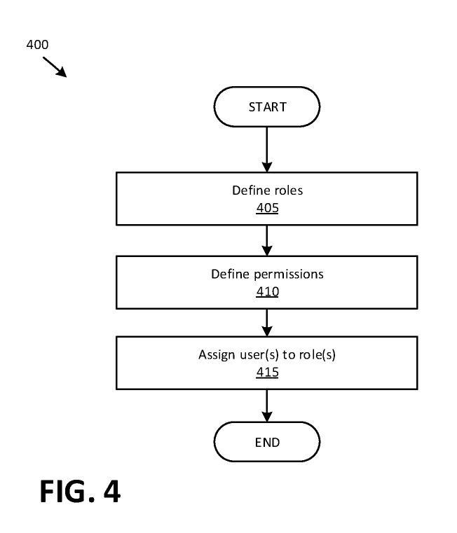

FIG. 4 illustrates an example process 400 for defining roles and associating permissions with the roles. For example, the computer 110 may be programmed to receive information indicating expected roles, permissions, and user data. For example, a vehicle owner may input this information via the HMI 145, a user device 155, or the server 165. The computer 110 may be programmed according to the process 400 to define roles and permissions, assign permissions to roles, and assign roles to users based on the received information.

The process 400 begins in a block 405, in which the computer 110 defines one or more roles, e.g., super user, adult passenger, etc., and permissions for each role, e.g., based on input from a vehicle owner or other user with administrator 205 access.

Next, in a block 410, the computer 110 stores the roles, i.e., including permissions associated with each role in a memory. Table 1 provides a partial example of roles and associated permissions, e.g., permission to authorize maintenance is assigned to the administrator 205 and super user 210 roles. However, the adult passenger 215, the guest adult passenger 220, the child 22, and the guest child 230 roles do not have the permission to authorize maintenance.

Next, in a block 415, the computer 110 assigns users to roles. The users may be identified by user IDs, passwords, or biometric characteristics such as a facial image, voice, or finger print. The computer 110 may store, e.g., a list, in a memory assigning user identifiers to the roles.

Following the block 415, the process 400 ends.

Processors such as discussed herein generally each include instructions executable by one or more processors such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in stored in a processor is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A computer, comprising a processor and a memory, the memory storing instructions executable by the processor such that the computer is programmed to:
receive data including vehicle occupant authentication information'
receive a request to control a vehicle component;
identify a role for the vehicle occupant;
determine whether the identified role includes a permission to control the vehicle component; and
perform the requested control of the vehicle component if the identified role includes the permission to control the vehicle component.

2. The computer of claim 1, wherein the computer is further programmed to decline the requested control of the vehicle component if the identified role lacks the permission to control the vehicle component.

3. The computer of claim 1, wherein the computer is further programmed to perform the requested control of the vehicle component when the identified role lacks the permission to control the vehicle component if the computer receives an override input from a remote device.

4. The computer of claim 1, wherein the authentication information includes biometric data of the vehicle occupant.

5. The computer of claim 1, wherein the vehicle component is a vehicle actuator.

6. The computer of claim 1, wherein the computer is programmed to receive the request to control from a device associated with the vehicle.

7. The computer of claim 1, wherein the computer is programmed to receive the request to control from a remote device outside the vehicle.

8. The computer of claim 1, wherein one of a plurality of roles is associated to the vehicle occupant, and each of the plurality of roles includes one or more permissions.

9. The computer of claim 8, wherein the one or more permissions include a permission to authorize initiation of travel remotely.

10. The computer of claim 1, wherein the computer is further programmed to perform the requested control of the vehicle component at least in part by modifying a setting of the vehicle component.

11. The computer of claim 1, wherein the computer is further programmed to:
define one or more roles based on a second input data, each of the one or more roles including one or more permissions; and
assign one of the one or more roles to the vehicle occupant.

12. The computer of claim 11, wherein the computer is further programmed to receive the second input data from a remote device.

13. The computer of claim 11, wherein the computer is further programmed to change the role assigned to the vehicle occupant based at least in part on the second input data.

14. The computer of claim 13, wherein the second input data indicates a change of ownership of the vehicle.

15. The computer of claim 11, wherein the computer is further programmed to:
define one or more groups of vehicle occupants; and
assign one of the one or more roles to the one or more groups, wherein the one of one or more roles assigned to one of the one or more groups applies to each of the vehicle occupants included in the respective group.

16. A method, comprising:
receiving data including vehicle occupant authentication information;
receiving a request to control a vehicle component;
identifying a role for the vehicle occupant;
determining whether the identified role includes a permission to control the vehicle component; and
performing the requested control of the vehicle component if the identified role includes the permission to control the vehicle component.

17. The method of claim 16, further comprising declining the requested control of the vehicle component if the identified role lacks the permission to control the vehicle component.

18. The method of claim 16, wherein the request to control is received from a remote device outside the vehicle.

19. The method of claim 16, further comprising:
defining one or more roles based on a second input data, each of the one or more roles including one or more permissions; and
assigning one of the one or more roles to the vehicle occupant.

20. The method of claim 19, further comprising:
defining one or more groups of vehicle occupants; and
assigning one of the one or more roles to the one or more groups, wherein the one of one or more roles assigned to one of the one or more groups applies to each of the vehicle occupants included in the respective group.
